(19) United States
(12) Patent Application Publication
(10) Pub. No.: US 2016/0253549 A1
(43) Pub. Date: Sep. 1, 2016

(54) Estimating personal information from facial features

(71) Applicant: Leo Ramic, Newport Beach, CA (US)

(72) Inventor: Leo Ramic, Newport Beach, CA (US)

(21) Appl. No.: 14/634,130

(22) Filed: Feb. 27, 2015

(51) Int. Cl. G06K 9/00

(52) U.S. Cl. CPC G06K 9/00248

(57) ABSTRACT

This invention relates to systems and methods for face recognition and analysis.

The invention and embodiments disclosed here describe systems and methods for automated estimation of personal information from facial features.

### CROSS-REFERENCE TO RELATED APPLICATIONS

(Not Applicable).

### STATEMENT REGARDING FEDERALLY SPONSORED RESEARCH OR DEVELOPMENT

(Not Applicable).

### THE NAMES OF THE PARTIES TO A JOINT RESEARCH AGREEMENT

(Not Applicable).

### INCORPORATION-BY-REFERENCE OF MATERIAL SUBMITTED ON A COMPACT DISC OR AS A TEXT FILE VIA THE OFFICE ELECTRONIC FILING SYSTEM

Files submitted via the EFS-WEB system and other material submitted in conjunction with this patent application are hereby incorporated by reference.

### STATEMENT REGARDING PRIOR DISCLOSURES BY THE INVENTOR OR A JOINT INVENTOR

(Not Applicable).

### BACKGROUND OF THE INVENTION

1. Field of the Invention

This invention relates generally to the field of computer vision and face recognition.

2. Description of Related Art

Computerized face detection and recognition are widely used in many areas, from security and law enforcement to various commercial and personal uses.

Most of the published works in the current art are concentrated on:

a) Basic face detection, which generally consists of detecting the presence and location of faces in images or videos; and
b) Basic face recognition, which generally involves matching detected faces to previously stored faces (in various forms).
Efforts to improve the performance of face detection and recognition are directed mostly to additional image analysis and methods for image matching. These approaches often require additional time or resources, making them less usable for face recognition tasks under resource constraints, such as real-time recognition and recognition with devices with limited resources (such as security devices and smart-phones). Improving the face recognition without requiring additional time or resources could enable the use of face recognition on more devices, and expand the field of other potential uses.

Faces are a rich potential source of personal information. Analysis of faces in the present art is largely limited to matching faces to stored images. Research into detailed analysis of faces to derive more information about the person is limited. Extending the field of face analysis could help improve the face matching tasks and open new areas for use of computer vision applications.

For example, body weight management is the subject of increased attention from governments, health professionals and people around the world because of growing instances of obesity. Measuring and monitoring the weight is an essential part of body weight management. Solutions that make the body weight measuring and monitoring simpler or faster could be useful for weight management.

### BRIEF SUMMARY OF THE INVENTION

This invention relates to systems and methods for estimating personal information from facial features.

In an embodiment, estimating personal information from facial features includes: face detection, facial features detection, facial features analysis, and estimation of personal information from facial features.

Further embodiments described here include: enhanced facial features detection, estimation model preparation by model training, estimation of personal information based on trained estimation models, and various other features.

Objectives of the present invention are to improve the reliability of face recognition tasks, and to enable new uses of computer vision by providing useful information about persons from face images.

Analysis of facial features using predefined models, described in embodiments here, requires less time and resources, and is more robust to variations in pose and scale than the present art approaches based mostly on image processing. This approach enables a more reliable face recognition under a variety of conditions, provides for faster and more reliable face analysis, and enables the use of face recognition on devices with limited resources.

Embodiments presented here describe systems and methods for automated estimation of personal information, such the body mass index, gender, etc., from facial features. These embodiments represent a novel approach to face analysis by using detailed analysis of facial features based on estimation models, which allows for faster and more reliable estimates, and enable new uses of computer vision to estimate a range of personal information from face images.

The detailed description below describes further embodiments, features, and advantages of the invention, as well as the structure and operation of the various embodiments.

### BRIEF DESCRIPTION OF THE DRAWINGS

Embodiments of this invention are described with reference to the accompanying drawings. Similar reference numbers in the drawings may indicate identical or functionally similar elements.

FIG. 1 illustrates Estimating personal information from facial features.

FIG. 2 illustrates Estimation model preparation by model training.

FIG. 3 illustrates Enhanced facial features points example.

FIG. 4 illustrates Flowchart: Estimation model preparation by training.

FIG. 5 illustrates Flowchart: Estimation of personal information.

### DETAILED DESCRIPTION OF THE INVENTION

While this description refers to exemplary embodiments for particular applications, it should be understood that the invention is not limited by embodiments described here. Those skilled in the art with access to the teachings provided here will recognize additional modifications, applications, embodiments, and fields in which the invention would be of significant utility.

Embodiments of the present invention relate to systems and methods for estimating personal information from facial features.

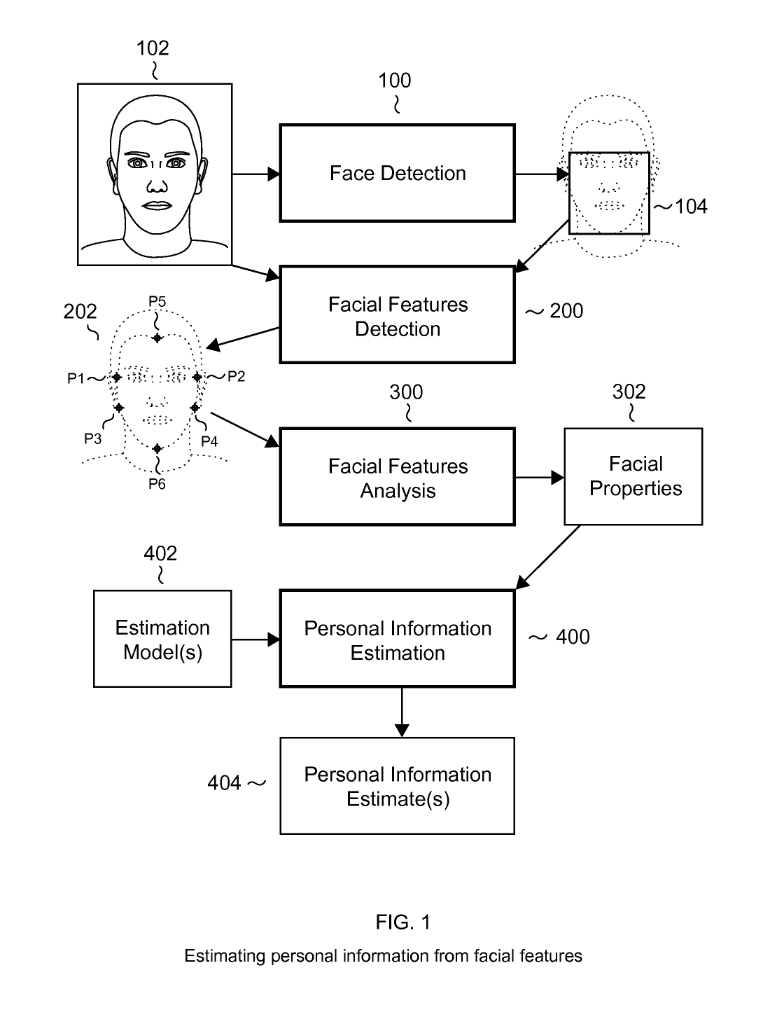

In an exemplary embodiment shown in FIG. 1, a system and a method for estimating personal information from facial features uses at least one processor and comprises:

analyzing an image and detecting a face in the image;
detecting facial features related to the face;
analyzing facial features and determining facial features properties; and
estimating personal information related to the face from results of the facial features analysis using at least one predefined estimation model.

Embodiments for personal information estimation generally include these elements:

### 1. Face Detection (100);

### 2. Facial Features Detection (200);

### 3. Facial Features Analysis (300);

### 4. Personal Information Estimation (400).

### 1. Face Detection.

The face detection element (100) is a module/method for automatic face detection. The face detection element (100) analyzes one or more images (102) to detect faces. Face detection elements commonly used in the art are usually based on object detectors suitable for face detection, such as the Haar and LBP classifiers. Other types of detectors may be also used for the purpose of face detection.

The face detection (100) may be incorporated into the facial features detection (200). The result of face detection is one or more sets of coordinates of rectangles (104) representing the approximate location and size of faces detected.
The face detection element (100) may also detect the location and/or size of the eyes, the mouth, etc., in order to improve the reliability of face detection and to assist in detection of other facial features.

### 2. Facial Features Detection.

The facial features detection element (200) is a module/method for automatic detection of facial features. Detection of facial features in the art is often based on the “Active Shape Model” (ASM), or the “Active Appearance Model” (AAM) detection models. Other models for detection of facial features may be used for this purpose. The facial features detection element (200) may incorporate the face detection element (100). A separate face detection step is not required for detection of facial features, but is often used for performance reasons because it reduces the search area for facial features detections, which improves the speed of detections, and may also improve the reliability of detections of facial features.

The facial features detection element (200) searches the area within and around the face area to detect detailed features of the face, referred to as “facial features” (202). The result of facial features detection is a set of one or more coordinates or points (202). These points indicate the approximate location of detected facial features, and may indicate an approximate outline (contour) of one or more facial features. Facial feature detectors commonly provide points indicating a partial outline of the lower face region, the eyes and the mouth. Facial feature detectors may provide additional points for other facial features (such as the nose and eyebrows), or for more detailed outlines.
2b. Enhanced Facial Features Detection.

In an embodiment, the element for detection of facial features (200) is a module/method for enhanced detection of facial features. The enhanced detection of facial features produces additional facial features points which are not reliably provided by most detectors in the present art, but are useful for improving the detail and reliability of face recognition, facial features detections and estimates of personal information from facial features.

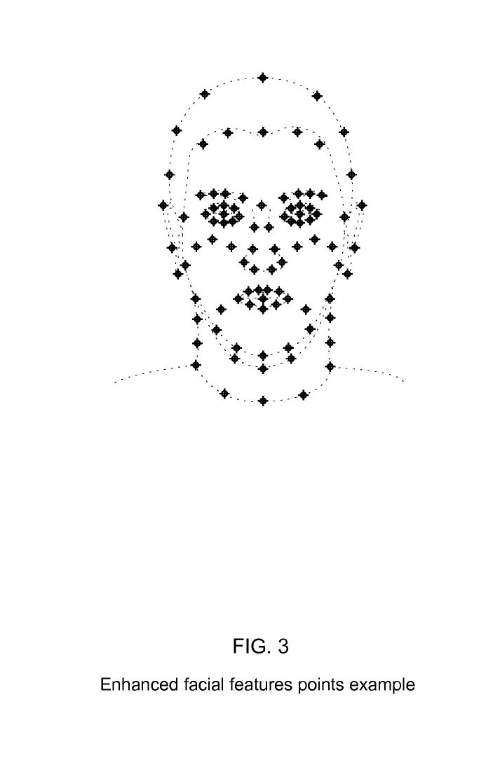

FIG. 3 shows an example of facial feature points produced by the enhanced detection of facial features. Note that the number and locations of points shown in FIG. 3 are limited due to the practical drawing visibility and space consideration; many additional and intervening points may be produced by the enhanced detection of facial features.

The enhanced detection of facial features may provide additional points which correspond to, for example, the approximate location and/or partial outline of the:

a) Top of the forehead.
The forehead points are useful for estimating the height and shape of the face.
b) Neck region.
The neck region points are useful for improving estimates of the size and shape of the face, and for detecting other features, such as the double-chin or beard. Detection of double-chin is useful for improving estimates of the body weight related information, and detection of the beard is useful for improving estimates of the gender.

### c) Cheeks.

The cheek points are useful for improving estimates of the size and shape of the face, and for improving estimates of the health and weight related information.
d) Hair region.
The hair region points are useful for improving estimates of the size and shape of the face, and for improving estimates of the gender.

In general, additional facial features points may be obtained by estimating additional points from already detected points, or by additional detection within the face region, and/or by extending the detection to the areas surrounding the face.

One or more of the following methods may be used, depending on the location and nature of the facial features to be detected:

a) Estimate additional points based on projections from other detected facial features. For example: create projection lines from appropriate points on the outline of the lower face region through appropriate points of the eye region, and calculate the intersection point between these projection lines to obtain one or more points with an approximate location of the forehead top and/or outline.

b) Estimate additional points from the points of an ellipsoid derived from other detected points.

For example: using the points of the outline of the lower face, calculate the ellipsoid that encompasses these points, then use the points of the part of the ellipsoid which covers the forehead to estimate the location of additional points of the forehead.

c) Estimate additional points based on the anthropological data and detected facial features.

For example: take one or more appropriate facial feature points, such as the location of the eye pupils, and use the anthropological data correlated to the eye pupil distance to obtain additional facial feature points from correlation to the eye pupil distance.

d) Detect additional points by extending the existing detection model, or by creating additional detection models, through model training for additional points.

For example: extend the detection model by additional training to create additional detection classifier or shape files to detect the forehead, neck, and other region points.

e) Detect additional points by using the edge or gradient detection methods.

For example: search the area below the face outline using an edge detection method to detect the outline of the double-chin region and/or the neck region.
For example: search the area between the mouth and face edges using a gradient detection method to detect the approximate outline of the cheeks.

f) Detect additional points by using the color detection and/or segmentation methods.

For example: use the skin color detection methods to determine the area of the face and neck region, then subtract the previously detected face region from this area to estimate the points of the neck outline.
For example: use the grab-cut methods to segment the areas of the face and background and determine the outline of the hair region.

Many other methods available in the art may be used to produce additional facial feature points. Methods for detection of additional facial feature points may be combined, and the selection of a method, or a combination of methods, will depend on the application, desired detection reliability, and resource and performance constraints.

### 3. Facial Features Analysis.

The facial features analysis element (300) is a module/method for automated facial feature analysis. The facial feature analysis element (300) analyzes facial feature points (202) produced by the facial features detector (200) and produces facial feature values or “facial properties” (302) describing the properties of the face.

The facial features analysis (300) may be used to produce facial feature values by normalizing the facial feature points detected by the facial features detection (200), by using, for example, the average distance between eye pupils as the normalization factor. Other normalization factors, such as the distance between the eyes and the mouth, may be used as the normalization factor. The normalization factor can be applied (by using one or more of operations such as multiplication, division, addition, subtraction, etc.) to facial feature points (202) to produce one or more normalized facial feature values. Normalized facial feature values may be used for further analysis of facial features, or may be used without further analysis. Normalized values are useful because they are scale-invariant and may reduce the need for further analysis of facial features.

In an embodiment, the facial features analysis element (300) uses the results of the facial features detection (200) to analyze facial features and determine various properties of the face (“facial properties”). The facial properties (302) may include: distances between facial feature points, relative sizes of facial features, contours, shapes and angles of facial features, ratios between locations, distances and sizes of facial features, and other facial properties ascertainable from detected facial features. Facial properties expressed in relative terms or ratios have the advantages that they are scale-invariant and may be directly correlated to measurements done by other means.

For example, the facial features analysis (300) may determine the following basic facial properties from facial feature points (202), as follows:
Note: Point references below refer to (P1) through (P6) in FIG. 1.
Equations are expressed using Computer Vision terminology.
   1. “Face Width” (D1): by calculating the distance between points P1 and P2.

D1=distance(P1,P2) (Eq. 1)

2. “Face Height” (D2): by calculating the distance between points P5 and P6.

D2=distance(P5,P6) (Eq. 2)

3. “Face Width to Height Ratio” (R1): by dividing D1 with D2.

R1=D1/D2 (Eq. 3)

4. “Lower Face Width” (D3): by calculating the distance between P3 and P4.

D3=distance(P3,P4) (Eq. 4)

5. “Face Width to Lower Face Width Ratio” (R2): by dividing D1 with D3.

R2=D1/D3 (Eq. 5)

Many other facial properties may be determined using the same facial features points. For example:

6. “Lower Face Perimeter” (PER1): by calculating the perimeter (contour) encompassed by points P1, P2, P4, P6, P3 and P1.

PER1=contour(P1,P2,P4,P6,P3,P1) (Eq. 6)

7. “Lower Face Area” (A1): by calculating the area enclosed by points P1, P2, P4, P6, P3 and P1.

A1=area(P1,P2,P4,P6,P3,P1) (Eq. 7)

8. “Lower Face Perimeter to Area Ratio” (PAR1): by dividing PER1 with A1.

PAR1=PER1/A1 (Eq. 8)

9. “Face Perimeter” (PER2): by calculating the perimeter (contour) encompassed by points P1, P5, P2, P4, P6, P3 and P1.

PER2=contour(P1,P5,P2,P4,P6,P3,P1) (Eq. 9)

10. “Face Area” (A2): by calculating the area enclosed by points P1, P5, P2, P4, P6, P3 and P1.

A2=area(P1,P5,P2,P4,P6,P3,P1) (Eq. 10)

11. “Face Perimeter to Area Ratio” (PAR2): by dividing PER2 with A2.

PAR2=PER2/A2 (Eq. 11)

Depending on the desired application and resource constraints, the facial features analysis (300) may be used determine only some facial properties considered relevant for the task, or it may be used determine all facial properties which can be determined from all detected facial features. Additional properties may be determined from facial features using the previously described “Enhanced Facial Features Detection”, or analogous methods, as appropriate. The facial properties (302) may be subjected to further analysis, such as the statistical significance analysis, Principal Component Analysis, etc., to determine facial properties most relevant for further analysis, or the facial properties (302) may be used without further analysis as a set of weak classifiers.

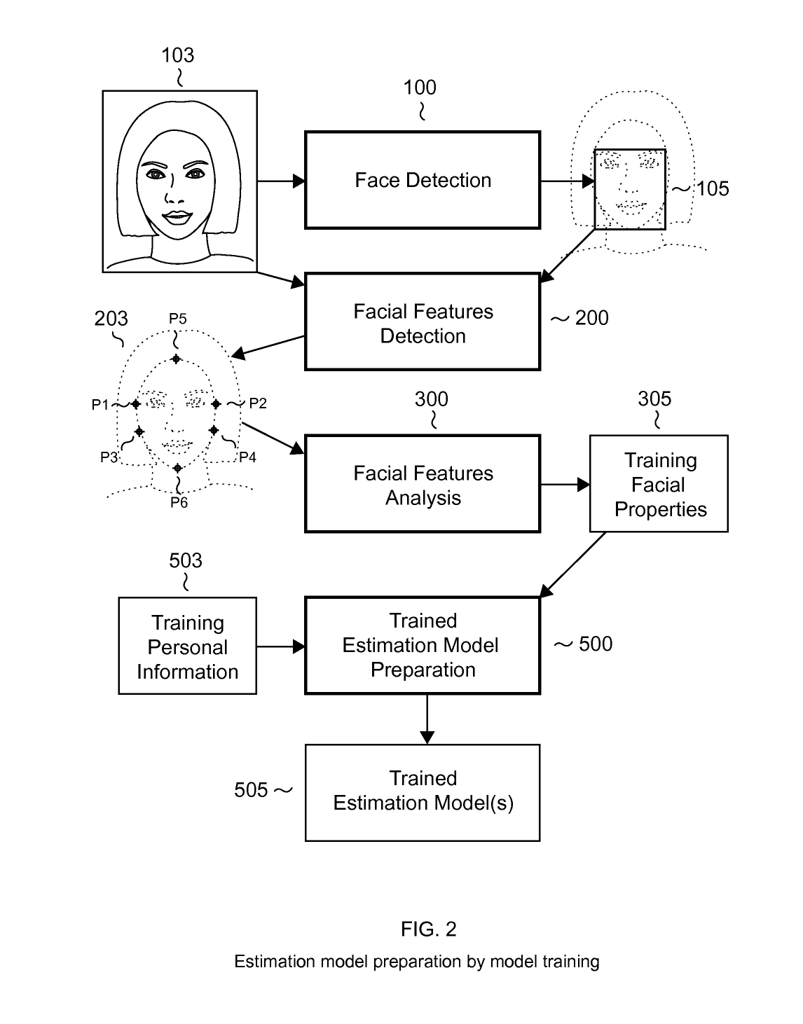

The facial properties (302) may be used for preparation of estimation models by training (FIG. 2), and for estimation of personal information from facial features (FIG. 1). In general, facial properties of the same type will be used for model preparation and for estimation based on such model.

### 4. Estimating Personal Information.

The element for estimating personal information (400) is a module/method for automated personal information estimation. The personal information estimation element (400) uses results of the facial features analysis (300) and one or more estimation models (402) to produce estimates of personal information (404).

The personal information estimation element (400) may employ various methods of data analysis, classification and machine learning to analyze the facial features, or facial properties derived from facial features, and to correlate data to predefined models for estimation (402), and produce estimates of various personal information (404).

Some of the methods commonly used for data analysis, classification and machine learning are: Linear Regression, Logistic Regression, Principal Component Analysis (PCA), Support Vector Machines (SVM), Neural Networks (NN), Linear Discriminant Analysis (LDA), Regression Splines, Mahalanobis' Distance classification, Random Trees, Random Forests, Nearest Neighbor classifications, and so on.
Methods for data analysis, classification and machine learning may be combined for increased reliability of results. The optimal method, or a combination or methods, for a particular application will depend on the nature of the data analyzed, desired accuracy, and resource and performance constraints.

The estimation model (402) may be prepared from statistical or anthropological data, or may be prepared by the model preparation by model training (FIG. 2).

4a. Estimation Model Preparation from Statistical or Anthropological Data.

Estimation models prepared from statistical or anthropological data may be based on one or more relevant known values or correlations. These models do not have to be formalized into separate elements; the known values or correlations may be directly applied to the data analyzed to produce estimates. Advantages of these models are that they are relatively simple to prepare because they do not require the training process and training data. Disadvantages of these models are that they may be based on fixed formulas and limited amount of data, which makes them less suitable for dynamic changes in analysis and limits the areas of useful application, and they may not be suitable for estimates where correlations are weak or entirely unknown.

4b. Estimation Model Preparation by Training.

Estimation model preparation by model training is shown in FIG. 2. Advantages of models based on model training (505) are their flexibility in modeling and the ability of these models to discover and leverage weak or unknown correlations in data. Disadvantages of models based on training are that preparation may require significant time and resources, and explanations of results and confidence levels may be limited.

In an exemplary embodiment shown in FIG. 2, a system and a method for estimation model preparation by model training includes the following elements:

### Face Detection (100);

### Facial Features Detection (200);

### Facial Features Analysis (300);

### Trained Estimation Model Preparation (500).

The face detection (100), the facial features detection (200), and the facial features analysis (300) elements perform steps equivalent to corresponding elements described in the preceding estimation embodiments, with the difference that the images analyzed (103) are training images, and results (203, 305) are derived from the training images.

The trained estimation model preparation element (500) applies one or more methods for data analysis, classification or machine learning (described in the previous section “Estimating Personal Information”), to one or more instances of training data (305 and 503). Parameters for the data analysis may be adjusted for desired reliability and performance.

The training data for the estimation model preparation includes:

a) Training facial properties (305) derived from the facial features analysis (300), and
b) Known or estimated training personal information (503) corresponding to the faces in training images being analyzed.

For better results with some models, the training data may be pre-scaled or otherwise transformed to minimize the influence of large numbers, and may include adjustments (such as “class weights”) for specific facial properties or training data instances. The training data may be stored in an internal or external memory, files or databases, or encoded as meta-data in file names, or stored as meta-data within the images being analyzed.

Models for estimation (505) are generally constructed for each type of personal information (such as the body mass index, gender, etc.) to be estimated. For personal information types which can be correlated to some other personal information type, multiple type or category-dependent estimation models may be constructed in order to improve the accuracy and reliability of estimation results.

4c. Producing Estimates.

Estimates of personal information (404) may be produced by applying one or more estimation models (402) to the facial feature values or facial properties (302) produced by the facial features analysis (300) from faces being analyzed (102).

Models for estimation (402) may be combined to improve the reliability of estimates and to minimize the influence of outliers in the data analyzed. The optimal approach for estimation of personal information depends on the type of personal information being estimated, desired reliability of estimates, and resource and performance constraints.

The results of estimation (404) may be numerical or categorical, depending on the type of personal information and the estimation model used. The estimation results (404) may include confidence or probability levels for the estimates, which can be used for further refinement of estimates when multiple estimation models are used.

The results of estimation (404) may be used to improve the accuracy of estimations for other types of personal information. For example, values and correlation factors of some facial features which correlate to the body mass index (BMI) may differ with the gender, age and/or ethnicity. To improve the accuracy of the BMI estimate, it may be useful to estimate the gender, age and/or ethnicity, and then apply a model for estimation of the BMI which was prepared by taking the gender, age and/or ethnicity into account.

In an embodiment, estimates of personal information from facial features are obtained by:

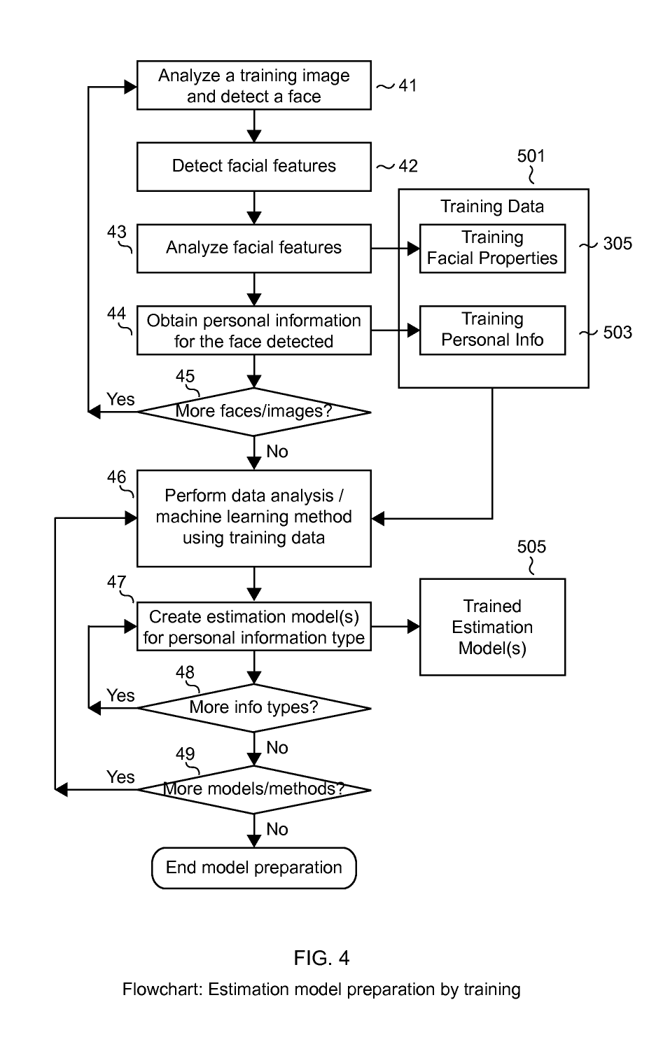

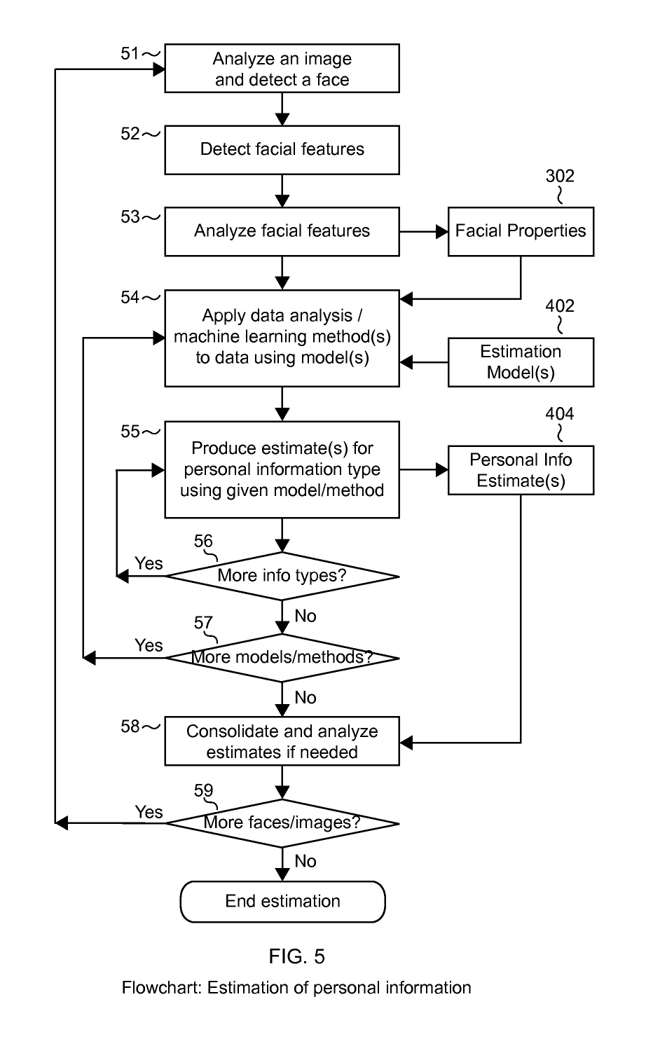

a) Preparing estimation model(s) by training, as shown in FIG. 4, and
b) Producing estimates of personal information, as shown in FIG. 5.

a) Preparing Estimation Model(s) by Training.

The flowchart in FIG. 4 shows the general outline of the estimation model preparation, also described previously, and further described here as follows:

Step (41): Analyze a training image and detect a face in the image. Continue if one or more faces are detected. If no faces are detected, analyze the next training image.

Step (42): Detect facial features related to the face. The facial features to detect is usually defined by the application requirements and may depend on the facial feature detector used. See “Facial Features Detection” above for more details.

For example: detect points (P1) through (P6) shown in FIG. 2;
or detect all points shown in FIG. 3.

Step (43): Analyze the facial features and produce facial properties (305).

The types and forms of facial features values or properties to be produced is usually defined by the application requirements. See “Facial Features Analysis” above for more details.
For example: determine the “Face Width to Height Ratio” (R1) and “Face Width to Lower Face Width Ratio” (R2), described above under “Facial Features Analysis”.
Or produce all available facial properties from all detected facial features points.

Store the facial features analysis results (305) into training data records (501). The training data are usually organized into records for each face and may be further grouped by the personal information type, such as the gender, age, etc.

Step (44): Retrieve (or obtain by other means) the relevant personal information (503) related to the face being analyzed. The relevant personal information is the information which is intended to be estimated by the estimation process.

The personal information data (503) may include all personal information available, or just the personal information which is required for the estimation application, such as, for example: the gender, age, age range, ethnicity, body mass index, body weight category, etc.

The personal information data may be known or estimated, or it may be calculated from other personal information available.

For example:
The body mass index (BMI) is commonly used as an indicator of body fatness.
The BMI can be calculated from a person's weight and height as follows:

BMI=weight_kg/(height_meters×height_meters) (Eq. 12)

BMI=weight_lbs×703/(height_inches×height_inches) (Eq. 13)

The body weight category (BWC) corresponds to the BMI as follows:

TABLE 1
Body Weight Category and BMI

| BW Category | Corresponding BMI |
|---|---|
| Underweight: | BMI from 0 to 18.4 |
| Normal weight: | BMI from 18.5 to 24.9 |
| Overweight: | BMI from 25 to 29.9 |
| Obese: | BMI from 30 to 39.9 |
| Morbidly Obese: | BMI above 40 |

Add the personal information to the training data (501) for this face

Step (45): If there are other faces detected in the image, or there are more training images, repeat the above steps (41) through (44) until all faces and images have been analyzed.

Step (46): Analyze the training data (501) produced above, by using one or more of selected methods for data analysis, classification or machine learning.

Use the facial properties (305) as predictor (independent) variables, and the relevant personal information (503) as response (dependent) variables.
For example: use the “Face Width to Height Ratio” (R1) and “Face Width to Lower Face Width Ratio” (R2), determined in the previous step (43), as independent variables, and the BMI value for the face analyzed as a dependent variable. This data may be normalized according to the requirements of the method(s) used in order to improve the prediction reliability.

Step (47): Create a trained estimation model (505).

For example, apply the Linear Regression method to the training data and create a linear regression model for estimation of the BMI.
Or, as another example, use all available facial properties and personal information data and apply the SVM method to create multiple SVM models for estimation of each personal information type (such as the BMI, gender, age, etc.).
Additional category-dependent estimation models may be also created for personal information types which are correlated to other personal information types, such as the estimation model for the BMI based on the gender, etc.

Store the created trained estimation model (505) for use in the estimation of personal information.

Step (48): If the estimation models (505) are being prepared for more personal information types (such as: gender, age, etc.), repeat the above model creation step (47) for each personal information type, until all such estimation models are created.

Step (49): If the estimation models (505) being prepared are based on several data analysis/machine learning methods, repeat the above steps (46) through (48), until all such methods have been applied and all required estimation models prepared.

b) Producing Estimates of Personal Information.

The flowchart in FIG. 5 shows the general outline of the estimation of personal information, also described previously, and further described here as follows:

Step (51): Analyze the image subject to estimation and detect a face in the image. Continue if one or more faces are detected. If no faces are detected and there are more images, analyze the next available image.

Step (52): Detect facial features related to the face. The facial features to detect is usually defined by the application requirements, based on the estimation model(s) and the facial feature detector used. See “Facial Features Detection” above for more details. Generally, the facial features to detect will include facial features on which the prepared estimation models are based.

For example: detect points (P1) through (P6) shown in FIG. 1;
or detect all points shown in FIG. 3.

Step (53): Analyze the facial features and produce the required facial properties (302). The types of facial properties produced by this analysis should correspond to the types of facial properties used in the previously defined estimation model(s).

See “Facial Features Analysis” above for more details.
For example: determine the “Face Width to Height Ratio” (R1) and “Face Width to Lower Face Width Ratio” (R2), described above under “Facial Features Analysis”.
Or, produce all available facial properties from all detected facial features points.

Step (54): Apply one or more of the previously selected methods for data analysis, classification or machine learning, using the corresponding previously defined estimation model(s) (402).

Use the facial properties (302) as predictor (independent) variables.
For example: use the “Face Width to Height Ratio” (R1) and “Face Width to Lower Face Width Ratio” (R2), determined in the previous step (53), as independent variables.
These values should be normalized according to the requirements of the corresponding estimation model if such estimation model is based on normalized values.

Step (55): Produce the estimates (404) for the personal information types being estimated, using the selected data analysis/machine learning methods and predefined estimation models.

For example, produce an estimate of the BMI value using the Linear Regression method and a previously defined linear regression BMI estimation model.
Or, produce an estimate of the BMI value using the SVM method and a previously defined SVM BMI estimation model.
Or, as another example, use all available facial properties and personal information data and apply the SVM method and all predefined SVM models to estimate all personal information types (such as the BMI, BWC, gender, age, age range, ethnicity, etc.) which can be reliably estimated from the data and estimation models available.
Note that for estimates of personal information types correlated to other personal information types (such as, for example, the estimate of the BMI based on the gender), the correlated personal information type (such as the gender), should be estimated first in order to select and apply the appropriate estimation method and model.

Store the personal information estimate (404) for further analysis or display.

Step (56): If several personal information types (such as: the gender, age, etc.) are being estimated for this face, repeat the above step (55) until estimates for each personal information type are produced.

Step (57): If several data analysis/machine learning methods and/or estimation models are used for estimation, repeat the above steps (54) through (56) until all data analysis/machine learning methods and estimation models have been applied and all estimates (404) obtained.

Step (58): Consolidate and analyze the estimation results (404) if needed. When multiple estimates of the same personal information type are obtained by using multiple methods and models (for example, two BMI estimates are produced by using the Linear Regression and SVM methods and models), such estimates may be analyzed and consolidated into one estimate for each type of personal information by using, for example, mean values, model weights, or other data analysis methods. The results of estimates (404) may be further analyzed to produce more reliable results. For example, values for the BMI and the BWC are related to each other, and may be analyzed for discrepancy between these two estimates, and reevaluated or adjusted to produce consistent estimates with the highest confidence level.

Step (59): If more than one face or image is being estimated, the above estimation steps (51) through ((58) may be repeated until all personal information estimates for all faces are produced.

The above embodiment would be the preferred embodiment for obtaining most relevant personal information with high confidence level and modest resource requirements.

Other types of personal information, such as some medical conditions, the mood, etc. may be estimated by using one or more of the above described embodiments, or variations thereof, depending on the type of personal information, the amount and reliability of the statistical or training data available for preparation of the models for estimation, desired reliability of the estimates, the data analysis methods and estimation models used, and the application performance and resource constraints.

Those skilled in the art will recognize that a variety of different embodiments can be realized with little effort to produce estimates for other personal information which can be correlated to facial features and/or to improve on embodiments described here by using other methods for face detection, facial feature detection and facial feature analysis, or by applying one or more of the numerous other methods for data analysis, classification, machine learning and estimation.

1-16. (canceled)

17. A method performed by one or more processors, the method comprising:
a) preparing one or more model data, comprising:
analyzing one or more images and detecting one or more faces in said images;
determining at least six facial features related to each said detected face, wherein said facial features represent approximate locations of salient points within or surrounding said face;
determining at least six facial properties from said facial features, wherein said facial properties are defined as scale-invariant ratios derived from said facial features;
obtaining one or more personal information associated with said face;
creating one or more model data from said facial properties and said personal information, wherein said facial properties are associated with said personal information;
b) preparing one or more estimation models, comprising:
accessing one or more said model data;
analyzing said model data by using one or more data analysis methods, wherein said data analysis methods comprise analysis, classification or learning of correlation of one or more said facial properties and one or more said personal information in said model data;
creating one or more estimation models derived from said data analysis; and
c) producing one or more estimates of personal information, comprising:
analyzing one or more images and detecting one or more faces in said images;
determining at least six facial features related to each detected face, wherein said facial features correspond to the facial features used in the preparation of said model data;
determining at least six facial properties from said facial features, wherein said facial properties correspond to the facial properties used in the preparation of said model data;
accessing one or more said estimation models;
analyzing said facial properties by using one or more said estimation models;
producing one or more estimates of one or more personal information;

18. The method of claim 17, wherein the facial features comprise actual, calculated or estimated facial features.

19. The method of claim 17, wherein the personal information comprises actual, calculated or estimated personal information.

20. The method of claim 17, wherein the estimates of one or more personal information are used for estimating one or more of other personal information.

21. The method of claim 17, wherein the personal information is the body height.

22. The method of claim 17, wherein the personal information is the body weight.

23. The method of claim 17, wherein the personal information is the gender.

24. The method of claim 17, wherein the personal information is the age.

25. The method of claim 17, wherein the personal information is the age range.

26. The method of claim 17, wherein the personal information is the ethnicity.

27. A system comprising one or more processors configured to perform operations comprising:
a) preparing one or more model data, comprising:
analyzing one or more images and detecting one or more faces in said images;
determining at least six facial features related to each said detected face, wherein said facial features represent approximate locations of salient points within or surrounding said face;
determining at least six facial properties from said facial features, wherein said facial properties are defined as scale-invariant ratios derived from said facial features;
obtaining one or more personal information associated with said face;
creating one or more model data from said facial properties and said personal information, wherein said facial properties are associated with said personal information;
b) preparing one or more estimation models, comprising:
accessing one or more said model data;
analyzing said model data by using one or more data analysis methods, wherein said data analysis methods comprise analysis, classification or learning of correlation of one or more said facial properties and one or more said personal information in said model data;
creating one or more estimation models derived from said data analysis; and
c) producing one or more estimates of personal information, comprising:
analyzing one or more images and detecting one or more faces in said images;
determining at least six facial features related to each detected face, wherein said facial features correspond to the facial features used in the preparation of said model data;
determining at least six facial properties from said facial features, wherein said facial properties correspond to the facial properties used in the preparation of said model data;
accessing one or more said estimation models;
analyzing said facial properties by using one or more said estimation models;
producing one or more estimates of one or more personal information;

28. The system of claim 27, wherein the facial features comprise actual, calculated or estimated facial features.

29. The system of claim 27, wherein the personal information comprises actual, calculated or estimated personal information.

30. The system of claim 27, wherein the value of one or more types of personal information is used for estimating one or more other types of personal information.

31. The system of claim 27, wherein the personal information is the body height.

32. The system of claim 27, wherein the personal information is the body weight.

33. The system of claim 27, wherein the personal information is the gender.

34. The system of claim 27, wherein the personal information is the age.

35. The system of claim 27, wherein the personal information is the age range.

36. The system of claim 27, wherein the personal information is the ethnicity.
